(19) United States
(12) Patent Application Publication
(10) Pub. No.: US 2022/0282088 A1
(43) Pub. Date: Sep. 8, 2022

(54) POLYAMIC ACID COMPOSITION, METHOD FOR PREPARING POLYAMIC ACID COMPOSITION AND POLYIMIDE COMPRISING THE SAME

(71) Applicant: PI ADVANCED MATERIALS CO., LTD., Chungcheongbuk-do (KR)

(72) Inventors: In Hwan Hwang, Seoul (KR); Gyeong Hyeon Ro, Gyeongsangnam-do (KR); Ik Sang Lee, Gyeongsangbuk-do (KR)

(21) Appl. No.: 17/624,834

(22) PCT Filed: Oct. 30, 2019
(86) PCT No.: PCT/KR2019/014424

§ 371 Date: Jan. 4, 2022

(30) Foreign Application Priority Data
Jul. 5, 2019 (KR) 10-2019-0081065

(51) Int. Cl. C08L 79/08; C08G 73/10

(52) U.S. Cl. CPC C08L 79/08; C08G 73/1039; C08G 73/1042; C08G 73/105; C08G 73/1071; C08L 2201/08; C08L 2203/16

(57) ABSTRACT

The present application relates to a polyamic acid composition, a method for preparing the polyamic acid composition, and a polyimide comprising the same, which provides a polyamic acid composition capable of implementing a low permittivity, and heat resistance and mechanical properties simultaneously, a method for preparing the polyamic acid composition and a polyimide comprising the same.

### CROSS-CITATION WITH RELATED APPLICATIONS

This application claims the benefit of priority based on Korean Patent Application No. 10-2019-0081065 dated Jul. 5, 2019, the disclosure of which is incorporated herein by reference in its entirety.

### TECHNICAL FIELD

The present application relates to a polyamic acid composition, a method for preparing the polyamic acid composition, and a polyimide comprising the same.

### BACKGROUND

A polyimide (PI) is a polymer material with thermal stability based on a rigid aromatic main chain, which has excellent mechanical properties such as strength, chemical resistance, weather resistance and heat resistance, based on chemical stability of imide rings.

Recently, various electronic devices have become thinner, lighter and smaller, and accordingly many researches have been conducted, which are intended to use a thin polyimide film being lightweight and having excellent flexibility as an insulating material for circuit boards or a display substrate capable of replacing a glass substrate for displays.

The polyimide has insulation properties and excellent electrical properties such as a low permittivity, thereby being applied to a wide range of industrial fields such as electronics, communications and optics, but has a technical limitation in implementing a permittivity below a certain level.

In the prior art, fluorine-based particles as an additive were formulated with a polyimide resin to realize the dielectric properties, but although this case can greatly reduce the permittivity, there is a problem of lowering heat resistance and mechanical properties of the film due to compatibility and dispersibility problems with the polyimide resin. Therefore, it is an important technical task to provide a polyimide that satisfies a permittivity, and heat resistance and mechanical properties simultaneously.

### DISCLOSURE

### Technical Problem

The present application provides a polyamic acid composition capable of implementing a low permittivity, and heat resistance and mechanical properties simultaneously, a method for preparing the polyamic acid composition, and a polyimide comprising the same.

### Technical Solution

The present application relates to a polyamic acid composition. The polyamic acid composition of the present application comprises a diamine monomer and a dianhydride monomer as polymerization units. In one example, the polyamic acid composition of the present application may comprise a non-fluorine-based diamine monomer and a non-fluorine-based dianhydride monomer as polymerization units, and may comprise at least one of a fluorine-based diamine monomer and a fluorine-based dianhydride monomer as polymerization units. The fact that the polyamic acid composition comprises the monomers as polymerization units means a state where a polymerization reaction has occurred between the respective monomers before curing into the polyimide. The polyamic acid composition may have a permittivity of 3.0 or less after curing, and also a glass transition temperature of 340° C. or more after curing. The upper limit of the permittivity is not particularly limited, which may be 2.95, 2.93, 2.9, 2.88, 2.86, 2.84, 2.82, 2.8 or 2.78, and the lower limit of the permittivity may be 1 or 1.5. In addition, the lower limit of the glass transition temperature is not particularly limited, but may be 345° C., 343° C., 345° C., 350° C., 360° C., 370° C., 375° C. or 379° C., and the upper limit of the glass transition temperature may be 500° C. or 400° C. The polyamic acid composition of the present application comprises the monomers, whereby it may provide a polyimide capable of simultaneously satisfying a low permittivity, and heat resistance and mechanical properties after curing.

In this specification, the fluorine-based diamine monomer and the fluorine-based dianhydride monomer may mean monomers including a fluorine atom in the molecular structure. The fluorine atom may be included in various positions and structures in the monomer, which are not particularly limited. For example, the fluorine-based diamine monomer and the fluorine-based dianhydride monomer may include at least one perfluoroalkyl group in the molecular structure. The perfluoroalkyl group may be, for example, a perfluoromethyl group. The present application comprises the fluorine-based monomers as polymerization units, whereby unlike conventionally including fluorine-based particles as an additive, it can lower the permittivity without the additive as well as compatibility and dispersibility problems of the particles, and accordingly can implement heat resistance and mechanical properties together.

In an embodiment of the present application, the fluorine-based diamine monomer and the fluorine-based dianhydride monomer may not be polymerized with each other. That is, in the polyamic acid composition of the present application, the fluorine-based diamine monomer and the fluorine-based dianhydride monomer do not react with each other, and may not directly meet each other in the entire polymerization unit. The prior art has lowered the permittivity using a fluorine-based additive, and the present invention uses a fluorine-based monomer, but there is a limit to sufficiently lowering the permittivity when only the fluorine-based monomer is used without the fluorine-based additive. However, the present application controls the polymerization method and polymerization sequence of the monomers, whereby it is possible to implement heat resistance and mechanical properties after curing together, while sufficiently lowering the permittivity.

In one example, the types of the fluorine-based diamine monomer and the fluorine-based dianhydride monomer of the present application are not particularly limited. In one example, the fluorine-based diamine monomer and the fluorine-based dianhydride monomer may have two or more benzene rings. In one example, the fluorine-based diamine monomer may have, for example, a perfluoroalkyl group that the hydrogen of the benzene ring is substituted. Also, in one example, the fluorine-based diamine monomer may have the above-described perfluoroalkyl group at an alkylene group connecting two benzene rings. Furthermore, in one example, the fluorine-based dianhydride monomer may have a perfluoroalkyl group that the hydrogen of the benzene ring is substituted, and in one example, it may also have the above-described perfluoroalkyl group at an alkylene group connecting two benzene rings.

In one example, the fluorine-based diamine monomer may be included in a range of 45 to 98 mol %, 48 to 95 mol %, or 49 to 92 mol %, relative to 100 mol % of the total diamine monomer. In addition, the fluorine-based dianhydride monomer may be included in a range of 5 to 60 mol %, 8 to 57 mol %, or 9 to 55 mol %, relative to 100 mol % of the dianhydride monomers. Meanwhile, when the total amount of the monomers has been 100 mol %, the total content of the fluorine-based diamine monomer and the fluorine-based dianhydride monomer may be included in a ratio of 20 to 70 mol %, 23 to 60 mol %, 30 to 58 mol %, 35 to 55 mol %, or 42 to 53 mol %. The present application can implement excellent dielectric properties, heat resistance and mechanical properties of the polyimide after curing by adjusting the content ratio of the monomers.

In this specification, the polyamic acid composition may be used in the same meaning as a polyamic acid solution.

The dianhydride monomer that can be used in the preparation of the polyamic acid solution may be an aromatic tetracarboxylic dianhydride, where the aromatic tetracarboxylic dianhydride may be exemplified by pyromellitic dianhydride (or PMDA), 3,3′,4,4′-biphenyltetracarboxylic dianhydride (or BPDA), 2,3,3,4′-biphenyltetracarboxylic dianhydride (or a-BPDA), oxydiphthalic dianhydride (or ODPA), diphenylsulfone-3,4,3′,4′-tetracarboxylic dianhydride (or DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, 3,3′,4,4′-benzophenonetetracarboxylic dianhydride (or BTDA), bis(3,4-dicarboxyphenyl)methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalenetetracarboxylic acid dianhydride, 1,4,5,8-naphthalenetetracarboxylic dianhydride, 4,4′-(2,2-hexafluoroisopropylidene)diphthalic add dianhydride, and the like.

The dianhydride monomer may be used alone or in combination of two or more as needed, but in consideration of the above-described bond dissociation energy, the present application may comprise, for example, pyromellitic dianhydride (PMDA), 3,3′,4,4′-biphenyltetracarboxylic dianhydride (s-RPDA) or 2,3,3′,4′-biphenyltetracarboxylic dianhydride (a-BPDA).

In addition, the diamine monomer that can be used for preparing the polyamic acid solution is an aromatic diamine, which may be classified and exemplified as follows.

1) diamines having a relatively rigid structure, as diamines having one benzene nucleus in structure, such as 1,4-diaminobenzene (or paraphenylenediamine, PDA), 1,3-diaminobenzene, 2,4-diaminotoluene, 2,6-diaminotoluene, 3,5-diaminobenzoic acid (or DABA), and the like;

2) diamines having two benzene nuclei in structure, such as diaminodiphenyl ethers of 4,4′-diaminodiphenyl ether (or oxydianiline, ODA), 3,4′-diaminodiphenyl ether, and the like, 4,4′-diaminodiphenylmethane (methylenediamine), 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5″-tetramethyl-4,4′-diaminodiphenylmethane, bis(4-aminophenyl)sulfide, 4,4′-diaminobenzanilide, 3,3′-dichlorobenzidine, 3,3′-dimethylbenzidine (or o-tolidine), 2,2′-dimethylbenzidine (or m-tolidine), 3,3′-dimethoxybenzidine, 2,2′-dimethoxybenzidine, 3,3′-diaminodiphenyl ether, 3,4′-diaminodiphenyl ether, 4,4′-diaminodiphenyl ether, 3,3′-diaminodiphenylsulfide, 3,4′-diaminodiphenylsulfide, 4,4′-diaminodiphenylsulfide, 3,3-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3-hexafluoropropane, 2,2-bis(4-aminophenyl)-1,1,1,3,3,3-hexafluoropropane, 3,3′-diaminodiphenylsulfoxide, 3,4′-diaminodiphenylsulfoxide, 4,4′-diaminodiphenylsulfoxide, and the like;

3) diamines having three benzene nuclei in structure, such as 1,3-bis(3-aminophenyl)benzene, 1,3-bis(4-aminophenyl)benzene, 1,4-bis(3-aminophenyl)benzene, 1,4-bis(4-amino)phenyl)benzene, 1,3-bis(4-aminophenoxy)benzene, 1,4-bis(3-aminophenoxy)benzene (or TPE-Q), 1,4-bis(4-aminophenoxy)benzene (or TPE-Q), 1,3-bis (3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, and the like;

4) diamines having four benzene nuclei in structure, such as 3,3′-bis(3-aminophenoxy)biphenyl, 3,3-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl] ether, bis[3-(4-aminophenoxy)phenyl] ether, bis[4-(3-aminophenoxy)phenyl] ether, bis[4-(4-aminophenoxy)phenyl] ether, bis[3-(3-aminophenoxy)phenyl] ketone, bis[3-(4-aminophenoxy)phenyl] ketone, bis[4-(3-aminophenoxy)phenyl] ketone, bis[4-(4-aminophenoxy)phenyl] ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane (BAPP), 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, 2,2-bis[4-(4-aminophenoxy)phenyl]-1,1,1,3,3,3-hexafluoropropane, and the like.

The diamine monomer may be used alone or in combination of two or more, if necessary, and in consideration of the above-described bond dissociation energy, the present application may comprise, for example, 1,4-diaminobenzene (PPD), 1,3-diaminobenzene (MPD), 2,4-diaminotoluene, 2,6-diaminotoluene or 4,4′-methylenediamine (MDA).

In one specific example, the polyamic acid composition may comprise 15 to 40 wt % of solid contents based on the total weight. The present application adjusts the solid content of the polyamic acid composition, whereby it is possible to prevent the increase in manufacturing cost and process time required to remove a large amount of solvent during the curing process while controlling the viscosity increase.

The polyamic acid composition of the present application may be a composition having a low viscosity characteristic. The polyamic acid composition of the present application may have a viscosity of 10,000 cP or less, or 9,000 cP or less, measured at a temperature of 23° C. and a shear rate of 1 s⁻¹, The lower limit is not particularly limited, but may be 500 cP or more, or 1000 cP or more. The viscosity may be measured using, for example, Haake's Rheostress 600, and may be measured under conditions of a shear rate of 1/s, a temperature of 23° C. and a plate gap of 1 mm. The present application provides a precursor composition having excellent processability by adjusting the viscosity range, whereby when forming a film or substrate, it is possible to form a film or substrate having desired physical properties.

In one embodiment, the polyamic acid composition of the present application may have a weight average molecular weight after curing in a range of 10,000 to 100,000 g/mol, 15,000 to 80,000 g/mol, 18,000 to 70,000 g/mol, 20,000 to 60,000 g/mol, 25,000 to 55,000 g/mol or 30,000 to 50,000 g/mol. In the present application, the term weight average molecular weight means a value converted to standard polystyrene measured by GPC (gel permeation chromatograph).

In the present application, the polyamic acid composition may comprise an organic solvent. The organic solvent is not particularly limited as long as it is an organic solvent in which the polyamic acid can be dissolved, but may be an aprotic polar solvent as one example.

The aprotic polar solvent may include, for example, amide-based solvents such as N,N′-dimethylformamide (DMF), N,N′-diethylformamide (DEF), N,N′-dimethylacetamide (DMAc) and dimethylpropaneamide (OMPA), phenolic solvents such as p-chlorophenol and o-chlorophenol, N-methyl-pyrrolidone (NMP), gamma butyrolactone (GBL) and diglyme, and the like, and these may be used alone or in combination of two or more.

In the present application, the solubility of the polyamic add may also be adjusted in some cases by using an auxiliary solvent such as toluene, tetrahydrofuran, acetone, methyl ethyl ketone, methanol, ethanol and water.

In one example, the organic solvent may be, for example, N-methyl-pyrrolidone (NMP).

Meanwhile, the polyamic acid composition of the present application may comprise a filler for the purpose of improving various properties of the film, such as sliding properties, thermal conductivity, conductivity, corona resistance, loop stiffness. The filler to be added is not particularly limited, but may include, for example, silica, titanium oxide, alumina, silicon nitride, boron nitride, calcium hydrogen phosphate, calcium phosphate, mica, and the like.

The particle diameter of the filler is not particularly limited, which may be determined according to the characteristics of the film to be modified and the type of the filler to be added. The average particle diameter may be 0.05 to 20 μm, 0.1 to 10 μm, 0.1 to 5 μm, or 0.1 to 3 μm. In this specification, the average particle diameter may be an average particle diameter measured according to D50 particle size analyses, unless otherwise specified.

By adjusting the particle diameter range, the present application may not lower the mechanical properties, without damaging the surface properties while sufficiently maintaining the modifying effect.

Also, in the present application, the additive amount of the filler is not particularly limited, which may be determined by the film characteristics to be modified or the particle diameter of the filler, and the like. In the present application, the additive amount of the filler may be 0.01 to 10 parts by weight, 0.01 to 5 parts by weight, or 0.02 to 1 part by weight relative to 100 parts by weight of the polyimide resin. By adjusting the content, the present application may not impair the mechanical properties of the film while sufficiently maintaining the modifying effect of the filler.

The method of adding the filler is not particularly limited, and a method known in similar industries may also be used.

The present application also relates to a method for preparing a polyamic acid composition. The preparation method may be a method for preparing the above-described polyamic acid composition.

In one example, the preparation method may comprise a first step of polymerizing two non-fluorine-based dianhydride monomers to both side amine groups of a fluorine-based diamine monomer; a second step of further polymerizing a non-fluorine-based diamine monomer to the polymerized non-fluorine-based dianhydride monomer and a third step of further polymerizing a fluorine-based or non-fluorine-based dianhydride monomer to the polymerized non-fluorine-based diamine monomer. In addition, the preparation method of the present application may comprise a first step of polymerizing two non-fluorine-based diamine monomers to both side anhydride groups of a fluorine-based dianhydride monomer; a second step of further polymerizing a non-fluorine-based dianhydride monomer to the polymerized non-fluorine-based diamine monomer and a third step of further polymerizing a fluorine-based or non-fluorine-based diamine monomer to the polymerized non-fluorine-based dianhydride monomer. Through the polymerization step of three steps, the present application may prevent from reacting the fluorine-based diamine monomer and the fluorine-based dianhydride monomer with each other, whereby it is possible to implement heat resistance and mechanical properties together with an excellent permittivity.

In an embodiment of the present application, first, the second step proceeding following the first step of polymerizing two non-fluorine-based dianhydride monomers to both side amine groups of a fluorine-based diamine monomer may comprise polymerizing two non-fluorine-based diamine monomers to the two non-fluorine-based dianhydrides. In addition, subsequently, the preparation method may comprise further polymerizing the polymerization units polymerized up to the second step to the two fluorine-based or non-fluorine-based dianhydride monomers. That is, the polymerization units polymerized up to the second step may be connected to each other via the fluorine-based or non-fluorine-based dianhydride. By adjusting such polymerization methods and the polymerization sequence thus generated, the present application can simultaneously implement heat resistance and mechanical properties together with low dielectric properties.

Similarly, in the second step proceeding following the first step of polymerizing two non-fluorine-based diamine monomers to both side anhydride groups of a fluorine-based dianhydride monomer, two non-fluorine-based dianhydride monomers may be polymerized to two non-fluorine-based diamine monomers. Also, subsequently, in the third step, two fluorine-based or non-fluorine-based diamine monomers may be polymerized to two non-fluorine-based dianhydride monomers. In addition, subsequently, in the preparation method, the polymerization units polymerized up to the second step may be further polymerized to the two fluorine-based or non-fluorine-based diamine monomers. That is, the polymerization units polymerized up to the second step may be connected to each other via the fluorine-based or non-fluorine-based diamine monomer. By adjusting such polymerization methods and the polymerization sequence thus generated, the present application can simultaneously implement heat resistance and mechanical properties together with low dielectric properties.

In general, the preparation of the polyamic acid solution uses, for example, a method in which the whole amount of the diamine monomer is put in a solvent, and then the dianhydride monomer is added thereto so as to be substantially equimolar to or in excess of the diamine monomer to be polymerized or a method in which the whole amount of the dianhydride monomer is put in a solvent, and then the diamine monomer is added thereto so as to be substantially equimolar to or in excess of the dianhydride monomer to be polymerized, and the like. Such a method may also be used in the preparation method of the present application.

The present application also relates to a polyimide, which is a cured product of the polyamic acid composition. In one example, the polyimide may be a cured product of the aforementioned polyamic acid composition or a precursor composition prepared by the method for preparing the same.

In addition, the present application may be a polyimide film comprising the polyimide in the form of a film or a sheet.

In one example, the present application relates to a method for producing a polyimide film. The present application may provide a method for producing a polyimide film comprising steps of: forming the polyamic acid composition into a film on a support and drying it to produce a gel film; and curing the gel film.

Specifically, with respect to a method for producing a polyimide film by imidizing the above-described polyamic acid composition; a conventionally known method may be used.

A specific example of such imidization may be exemplified by a thermal imidization method, a chemical imidization method, or a complex imidization method using the thermal imidization method and the chemical imidization method in combination, which will be described in more detail through the following non-limiting examples.

### Advantageous Effects

The present application provides a polyamic acid composition capable of implementing a low permittivity, and heat resistance and mechanical properties simultaneously, a method for preparing the polyamic acid composition and a polyimide comprising the same.

### BEST MODE

Hereinafter, the present invention will be described in more detail through Examples according to the present invention and Comparative Examples not according to the present invention, but the scope of the present invention is not limited by Examples presented below.

### Example 1

N-methyl-pyrrolidone (NW) was introduced into a 500 ml reactor equipped with a stirrer and nitrogen injection/discharge tubes while nitrogen was injected thereto, and after the temperature of the reactor was set to 30° C., 2,2′-bis(trifluoromethyl)benzidine (TFMB), a fluorine-based monomer, as a diamine monomer and pyromellitic dianhydride (PMDA), a non-fluorine-based monomer, as a dianhydride monomer were introduced to confirm that they were completely dissolved. Subsequently, 4,4′-Oxydianiline (ODA), a non-fluorine-based monomer, as a diamine monomer was introduced, and the polymerization reaction was performed in the same manner. Subsequently, 2,2-bis(3,4-anhydrodicarboxyphenyl)hexafluoropropane (6-FDA), a fluorine-based monomer, as a dianhydride monomer was introduced, and the temperature was raised to 40° C. and stirring was continued for 120 minutes while heating. Subsequently, the temperature was raised to 80° C. under a nitrogen atmosphere and stirring was continued for 2 hours while heating. The polymerization reaction was performed in the same manner to prepare a polyamic acid solution.

### Examples 2 to 4 and 6, and Comparative Examples 1 to 4 and 6

Polyamic acid compositions of Examples 2 to 4 and 6 were prepared in the same method as in Example 1, except that in Example 1, the monomers and their content ratios were changed as shown in Table 1 below. Polyamic acid compositions of Comparative Examples 1 to 4 and 6 were prepared in the same method as in Example 1, except that the monomers and their contents were each changed as shown in Table 1 below, and two types of diamine monomers and two types of dianhydride monomers were simultaneously introduced.

### Example 5 and Comparative Example 5

N-methyl-pyrrolidone (NMP) was introduced into a 500 ml reactor equipped with a stirrer and nitrogen injection/discharge tubes while nitrogen was injected thereto, and after the temperature of the reactor was set to 30° C., 4,4′-oxydianiline (ODA), a non-fluorine-based monomer, as a diamine monomer and pyromellitic dianhydride (PMDA), a non-fluorine-based monomer, as a dianhydride monomer were introduced to confirm that they were completely dissolved.

Subsequently, 2,2-bis(3,4-anhydrodicarboxyphenyl)hexafluoropropane (6-FDA), a fluorine-based monomer, as a dianhydride monomer was introduced, and the temperature was raised to 40° C. and stirring was continued for 120 minutes while heating. Subsequently, the temperature was raised to 80° C. under a nitrogen atmosphere and stirring was continued for 2 hours while heating. The polymerization reaction was performed in the same manner to prepare polyamic acid solutions.

TABLE 1

| | |
|---|---|
| Diamine | Dianhydride |

| | | ODA | TFMB | PMDA | 6-FDA |
|---|---|---|---|---|---|
| | | (mol %) | (mol %) | (mol %) | (mol %) |
| Example | 1 | 10 | 90 | 90 | 10 |
| | 2 | 30 | 70 | 70 | 30 |
| | 3 | 50 | 50 | 50 | 50 |
| | 4 | 50 | 50 | 70 | 30 |
| | 5 | 100 | 0 | 50 | 50 |
| | 6 | 75 | 25 | 75 | 25 |
| Comparative | 1 | 10 | 90 | 90 | 10 |
| Example | 2 | 30 | 70 | 70 | 30 |
| | 3 | 50 | 50 | 50 | 50 |
| | 4 | 50 | 50 | 70 | 30 |
| | 5 | 100 | 0 | 50 | 50 |
| | 6 | 75 | 25 | 75 | 25 |

Bubbles were removed from the polyamic acid compositions prepared in Examples and Comparative Examples above through high-speed rotation of 1,500 rpm or more. Thereafter, the defoamed polyamic acid compositions were each applied to a glass substrate using a spin coater. Thereafter, it was dried under a nitrogen atmosphere and at a temperature of 120° C. for 30 minutes to produce a gel film, and the temperature of the gel film was raised to 450° C. at a rate of 2° C./min, and it was heat-treated at 450° C. for 60 minutes, and cooled to 30° C. at a rate of 2° C./min to obtain a polyimide film. Thereafter, it was dipped in distilled water to peel the polyimide film from the glass substrate. The physical properties of the produced polyimide film were measured using the following method, and the results were shown in Table 2 below.

### Experimental Example—Thickness

The thickness of the produced polyimide film was measured using Anritsu's electric film thickness tester.

### Experimental Example 2—Measurement of Glass Transition Temperature

Using TA's dynamic mechanical analysis Q800 model, the polyimide film was cut into 4 mm wide and 20 mm long, and then the glass transition temperature was measured under a nitrogen atmosphere at a temperature increase rate of 5° C./min and under the condition of a temperature range from room temperature to 550° C. The glass transition temperature was determined as the maximum peak of tan δ calculated according to the ratio of the storage elastic modulus and the loss elastic modulus.

### Experimental Example 3—Permittivity and Dielectric Loss Tangent Values

The permittivity and dielectric loss tangent at 1 GHz of the polyimide films prepared in Examples and Comparative Examples were measured using Keysight's SPDR measuring instrument. As a result, the measured permittivity and dielectric loss tangent values were shown in Table 2 below.

TABLE 2

| | | | Glass | | Dielectric |
|---|---|---|---|---|---|
| | | | transition | | loss |
| | | Thickness | temperature | Permittivity | tangent |
| | | (μm) | (° C.) | (1 GHz) | (1 GHz) |
| Example | 1 | 19 | 340 | 2.8 | 0.0045 |
| | 2 | 18 | 344 | 2.75 | 0.0046 |
| | 3 | 21 | 355 | 2.84 | 0.0048 |
| | 4 | 19 | 355 | 2.87 | 0.0048 |
| | 5 | 20 | 380 | 2.86 | 0.0049 |
| | 6 | 19 | 378 | 2.97 | 0.0049 |
| Comparative | 1 | 19 | 315 | 3.05 | 0.0053 |
| Example | 2 | 18 | 320 | 3.06 | 0.0052 |
| | 3 | 21 | 320 | 3.10 | 0.0057 |
| | 4 | 19 | 325 | 3.18 | 0.0055 |
| | 5 | 20 | 332 | 3.22 | 0.0058 |
| | 6 | 19 | 338 | 3.25 | 0.0065 |

1. A polyamic acid composition comprising a non-fluorine-based diamine monomer and a non-fluorine-based dianhydride monomer as polymerization units, and comprising at least one of a fluorine-based diamine monomer and a fluorine-based dianhydride monomer as polymerization units, wherein the polyamic acid composition has a permittivity of 3.0 or less after curing and a glass transition temperature of 340° C. or more.

2. The polyamic acid composition according to claim 1, wherein the fluorine-based diamine monomer and the fluorine-based dianhydride monomer comprise at least one perfluoroalkyl group in the molecular structure.

3. The polyamic acid composition according to claim 1, wherein the fluorine-based diamine monomer and the fluorine-based dianhydride monomer do not polymerize with each other.

4. The polyamic acid composition according to claim 1, wherein the fluorine-based diamine monomer or the fluorine-based dianhydride monomer has two or more benzene rings.

5. The polyamic acid composition according to claim 1, wherein the fluorine-based diamine monomer is included in a range of 45 to 98 mol % relative to 100 mol % of the diamine monomers.

6. The polyamic acid composition according to claim 1, wherein the fluorine-based dianhydride monomer is included in a range of 5 to 60 mol % relative to 100 mol % of the dianhydride monomers.

7. The polyamic add composition according to claim 1, wherein the solid contents are in a range of 15 to 40%.

8. The polyamic acid composition according to claim 1, wherein the viscosity measured under conditions of a temperature of 23° C. and a shear rate of 1 s⁻¹ is 10,000 cP or less.

9. A method for preparing a polyamic acid composition comprising a first step of polymerizing two non-fluorine-based dianhydride monomers to both side amine groups of a fluorine-based diamine monomer; a second step of further polymerizing a non-fluorine-based diamine monomer to the polymerized non-fluorine-based dianhydride monomer and a third step of further polymerizing a fluorine-based or non-fluorine-based dianhydride monomer to the polymerized non-fluorine-based diamine monomer.

10. A method for preparing a polyamic acid composition comprising a first step of polymerizing two non-fluorine-based diamine monomers to both side anhydride groups of a fluorine-based dianhydride monomer; a second step of further polymerizing a non-fluorine-based dianhydride monomer to the polymerized non-fluorine-based diamine monomer and a third step of further polymerizing a fluorine-based or non-fluorine-based diamine monomer to the polymerized non-fluorine-based dianhydride monomer.

11. The method for preparing a polyamic acid composition according to claim 9, wherein in the second step, two non-fluorine-based diamine monomers are polymerized to two non-fluorine-based dianhydride monomers.

12. The method for preparing a polyamic acid composition according to claim 11, wherein in the third step, two fluorine-based or non-fluorine-based dianhydride monomers are polymerized to two non-fluorine-based diamine monomers.

13. The method for preparing a polyamic acid composition according to claim 12, wherein the polymerization units polymerized up to the second step are further polymerized to the two fluorine-based or non-fluorine-based dianhydride monomers.

14. The method for preparing a polyamic acid composition according to claim 10, wherein in the second step, two non-fluorine-based dianhydride monomers are polymerized to two non-fluorine-based diamine monomers.

15. The method for preparing a polyamic acid composition according to claim 14, wherein in the third step, two fluorine-based or non-fluorine-based diamine monomers are polymerized to two non-fluorine-based dianhydride monomers.

16. The method for preparing a polyamic acid composition according to claim 15, wherein the polymerization units polymerized up to the second step are further polymerized to the two fluorine-based or non-fluorine-based diamine monomers.

17. A polyimide which is a cured product of the polyamic acid composition of claim 1.

18. A polyimide film comprising the polyimide of claim 17 in the form of a film or sheet.
